(19) United States
(12) Patent Application Publication
(10) Pub. No.: US 2018/0371990 A1
(43) Pub. Date: Dec. 27, 2018

(54) ENGINE OPERABLE IN HORIZONTAL AND VERTICAL SHAFT ORIENTATIONS

(71) Applicant: Briggs & Stratton Corporation, Wauwatosa, WI (US)

(72) Inventor: Jerry Schenkel, Pewaukee, WI (US)

(73) Assignee: Briggs & Stratton Corporation, Wauwatosa, WI (US)

(21) Appl. No.: 16/060,846

(22) PCT Filed: Dec. 16, 2016
(86) PCT No.: PCT/US2016/067296

§ 371 Date: Jun. 8, 2018

Related U.S. Application Data
(63) Continuation-in-part of application No. 14/975,037, filed on Dec. 18, 2015.

(51) Int. Cl. F02B 75/34; F01P 1/02; F02B 75/00

(52) U.S. Cl. CPC F02B 75/34; F01M 11/0458; F02B 75/007; F01P 1/02

(57) ABSTRACT

A small air-cooled internal combustion engine includes an aluminum engine block including a cylinder extending along a longitudinal cylinder axis and a block mounting surface, a piston configured to reciprocate within the cylinder, a crankshaft coupled to the piston and configured to rotate about a crankshaft axis in response to reciprocation of the piston, and an aluminum crankcase cover including a cover mounting surface. The block mounting surface contacts the cover mounting surface. The block mounting surface and the cover mounting surface are both positioned at an angle to the crankshaft axis and the angle is not 90 degrees.

### CROSS-REFERENCE TO RELATED PATENT APPLICATIONS

This application claims priority to and is a continuation-in-part of U.S. application Ser. No. 14/975,037, filed Dec. 18, 2015, which is incorporated herein by reference in its entirety.

### BACKGROUND

The present application relates generally to the field of small air-cooled internal combustion engines, and particularly to the fields of engine blocks and crankcase covers for small air-cooled internal combustion engines.

### SUMMARY

One embodiment of the invention relates to a small air-cooled internal combustion engine including an aluminum engine block including a cylinder extending along a longitudinal cylinder axis and a block mounting surface, a piston configured to reciprocate within the cylinder, a crankshaft coupled to the piston and configured to rotate about a crankshaft axis in response to reciprocation of the piston, and an aluminum crankcase cover including a cover mounting surface. The block mounting surface contacts the cover mounting surface. The block mounting surface and the cover mounting surface are both positioned at an angle to the crankshaft axis and the angle is not 90 degrees.

Another embodiment of the invention relates to a small air-cooled internal combustion engine including an engine block including a cylinder extending along a longitudinal cylinder axis and a block mounting surface, a piston configured to reciprocate within the cylinder, a crankshaft coupled to the piston and configured to rotate about a crankshaft axis in response to reciprocation of the piston, and a crankcase cover including a cover mounting surface. The block mounting surface contacts the cover mounting surface. The block mounting surface and the cover mounting surface are both positioned at an angle to the crankshaft axis and the angle is not 90 degrees.

Another embodiment of the invention relates to a small air-cooled internal combustion engine including an aluminum engine block including a cylinder, a crankcase reservoir, and an outer surface, a piston positioned within the cylinder and configured to reciprocate within the cylinder, and a crankshaft coupled to the piston and configured to rotate about a crankshaft axis, wherein a portion of the crankshaft is located in the crankcase reservoir, where the outer surface of the engine block has an edge located a radial distance from the crankshaft axis and the radial distance is less than less than a standard minimum distance between the crankshaft axis and a horizontal mounting surface for a standard garden mounting flange for a horizontally-shafted engine. In some embodiments, the standard minimum distance is 4.25 inches. In some embodiments, the standard minimum distance is 6 inches. In some embodiments, the engine block does not include a lubricant inlet that allows a user to add lubricant to the crankcase reservoir. In some embodiments, a mechanical governor is not located in the crankcase reservoir. In some embodiments, the engine also includes an electronic governor for controlling engine speed. In some embodiments, in a first working orientation, the crankshaft is arranged vertically, and, in a second working orientation, the crankshaft is arranged horizontally. In some embodiments, the engine does not include a dipstick for measuring a lubricant level within the crankcase reservoir. In some embodiments, the cylinder is an aluminum cylinder block and an aluminum cylinder head welded to the cylinder block.

Another embodiment of the invention relates to a small air-cooled internal combustion engine including an aluminum engine block including a cylinder and a crankcase reservoir, wherein the engine block does not include a lubricant inlet that allows a user to add lubricant to the crankcase reservoir, a piston positioned within the cylinder and configured to reciprocate within the cylinder, and a crankshaft coupled to the piston and configured to rotate about a crankshaft axis, wherein a portion of the crankshaft is located in the crankcase reservoir. In some embodiments, the engine block does not include a lubricant inlet that allows a user to add lubricant to the crankcase reservoir. In some embodiments, the engine further includes an electronic governor for controlling engine speed. In some embodiments, in a first working orientation, the crankshaft is arranged vertically, and, in a second working orientation, the crankshaft is arranged horizontally. In some embodiments, the engine does not include a dipstick for measuring a lubricant level within the crankcase reservoir. In some embodiments, the cylinder is an aluminum cylinder block and an aluminum cylinder head welded to the cylinder block. In some embodiments, the engine block includes an outer surface having an edge located a radial distance from the crankshaft axis and the radial distance is less than a standard minimum distance between the crankshaft axis and a horizontal mounting surface for a standard garden mounting flange for a horizontally-shafted engine. In some embodiments, the standard minimum distance is 4.25 inches. In some embodiments, the standard minimum distance is 6 inches.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures.

FIG. 1 is an exploded perspective view of a standard small air-cooled engine, according to an exemplary embodiment.

FIG. 2 is a front elevation view of an engine, according to an exemplary embodiment

FIGS. 3A and 3B are rear elevation views of the engine of FIG. 2 with the crankcase cover removed.

FIG. 4 is an exploded perspective view of the engine of FIG. 2 and a cylinder head.

FIG. 5 is a perspective view from above of the cylinder head of FIG. 4.

FIG. 6 is a perspective view from below of the cylinder head of FIG. 4.

FIG. 7 is a schematic representation of an electronic governor system according to an exemplary embodiment.

FIG. 8 is a right side view of an engine, according to an exemplary embodiment.

FIG. 9 is a left side view of the engine of FIG. 8.

FIG. 10 is a front view of the engine of FIG. 8.

FIG. 11 is a top view of the engine of FIG. 8.

FIG. 12 is a section view of the engine of FIG. 8.

FIG. 13 is a perspective view from above of the engine block of the engine of FIG. 8.

FIG. 14 is a perspective view from below of the engine block of FIG. 13.

FIG. 15 is a right side view of the engine block of FIG. 13.

FIG. 16 is a right side view of the crankcase cover of the engine of FIG. 8.

FIG. 17 is a perspective view from below of the crankcase cover of FIG. 16.

FIG. 18 is a perspective view from above of the crankcase cover of FIG. 16.

FIG. 19 is a right side view of an engine, according to an exemplary embodiment.

FIG. 20 is a left side view of the engine of FIG. 19.

FIG. 21 is a front view of the engine of FIG. 19.

FIG. 22 is a rear view of the engine of FIG. 19.

FIG. 23 is a section view of the engine of FIG. 19.

FIG. 24 is a left side view of the crankcase cover of the engine of FIG. 19.

FIG. 25 is a front view of the crankcase cover of FIG. 24.

FIG. 26 is a rear view of the crankcase cover of FIG. 24.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Small air-cooled engines are typically manufactured for use as either vertical shaft engines in which the engine's crankshaft is arranged vertically when the engine is in its normal operating or working position or as horizontal shaft engines in which the engine's crankshaft is arranged horizontally in its normal operating or working position. Small engines used for lawn and garden equipment are typically mounted to the equipment powered by the engine with a garden mounting flange having industry standard dimensions. To accommodate these industry standard mounting flange dimensions, the geometries of the structural components of the engine (i.e., the engine block, cylinder, or crankcase cover) have had to be different for vertically- shafted engines than for horizontally-shafted engines. This is because the physical arrangement of the geometries of the standard garden mounting flange for a horizontally-shafted engine and the structural components of a vertically-shafted engine do not allow the mounting flange to be properly attached to the engine.

Changing the engine crankshaft orientation has also required changes in other components of the engine, particularly in the arrangement of the engine's lubrication system, including the oil sump (crankcase reservoir), the components that define the oil sump, which may include the engine block and the crankcase cover, the location of the oil inlet or fill tube for adding oil to the oil sump, the location of the dip stick for measuring the amount of oil in the oil sump, and the mechanism for distributing oil within the oil sump (e.g., an oil slinger, an oil pump), and/or different governors. Engine manufacturing would be simplified and could more rapidly respond to changes in customer needs if the same basic engine model could be used as either a vertical shaft engine or a horizontal shaft engine without having to change components of the engine to switch between shaft orientations or by only having to make minor changes non-structural components of the engine (i.e., not the engine block, cylinder, or crankcase cover). For example, such minor changes could include changing the orientation of the carburetor or selecting a connecting rod, oil slinger, or other internal component of the engine optimized for use in either a vertical shaft or a horizontal shaft orientation.

Advances in aluminum forming (e.g., casting, die casting, etc.) and welding (e.g., laser welding) allow structural components of an aluminum engine to be secured to one another without the use of mechanical fasteners (e.g., bolts) and avoid the shortcomings associated with such fasteners (e.g., providing robust mounting locations, distortion due to the torque required to secure the fasteners, the need for gaskets between components being secured to one another, etc.). These advances allow for a substantially sealed engine that does not require a user to add or change the oil of the engine. This allows components related to adding and changing oil (e.g., the oil inlet or fill tube, the dip stick, an oil drain) to be eliminated from the engine.

The small air-cooled engine described herein includes an engine block and crankcase cover that allow vertically-shafted and horizontally-shafted engines to share the same structural components. The engine is substantially sealed and eliminates components related to adding and changing oil. The engine also uses an electronic governor instead of a mechanical governor. Eliminating the mechanical governor, which is typically found within the oil sump, allows for a reduction in volume of the oil sump sufficient to change the geometry of the structural components of the engine so that the engine can be properly attached to either a standard garden mounting flange for a vertically-shafted engine or a standard garden mounting flange for a horizontally-shafted engine.

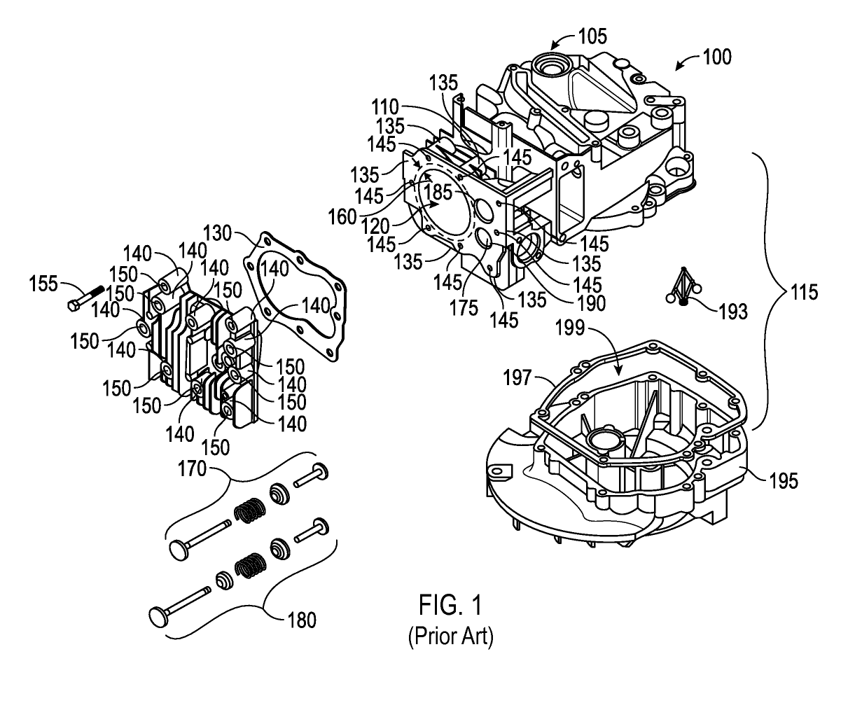

Referring to FIG. 1, a standard small air-cooled engine 100 is illustrated. The engine 100 includes an engine block 105 having a cylinder block 110 and a crankcase 115. The cylinder block 110 includes one or more cylinder bores 120, each receiving a piston. A cylinder head 125 is fastened to the cylinder block 110 above the cylinder bore 120 to close the cylinder bore 120. A head gasket 130 is positioned between the cylinder head 125 and the cylinder block 110 to seal the connection between the cylinder block 110 and the cylinder head 125. The cylinder block 110 and the cylinder head 125 each include multiple mounting locations or bosses 135, 140 positioned around the cylinder bore 120. A mounting aperture or opening 145, 150 is formed through each of the mounting locations 135, 140, respectively, and a bolt 155 is inserted through each pair of apertures 145, 150 to secure the cylinder head 125 to the cylinder block 110. As shown in FIG. 1, four bolts 155 are used to secure the cylinder head 125 to the cylinder block 110. The mounting apertures 145, 150 are located outside of a cylinder wall thickness 160. The cylinder wall thickness 160 is substantially constant for the length of the cylinder bore 120. Cooling fins may extend from the outer surface of the cylinder wall.

The cylinder block 110 also includes an intake port 165 in which an intake valve 170 is positioned and an exhaust port 175 in which an exhaust valve 180 is positioned. A valve seat 185, 190 is press fit to the cylinder block 110 around an aperture (e.g., opening) to each of the intake port 165 and the exhaust port 175.

The crankcase 115 houses the crankshaft to which the piston is coupled and also acts as a reservoir for lubricant (e.g., oil) for the internal components of the engine 100. The crankcase 115 includes a crankcase cover or sump 195 that is fastened to the engine block 105 to close the crankcase 115 (e.g., with multiple bolts). A lubricant inlet is provided to allow a user to add lubricant to the lubricant reservoir. A dipstick may be provided to allow a user to measure the lubricant level within the lubricant reservoir. The crankcase cover 195 is removable to provide access to the internal components of the engine 100. A crankcase gasket 197 is positioned between the cylinder block 110 and the crankcase cover 195 to seal the connection between the cylinder block 110 and the crankcase cover 195. A mechanical governor 193 is positioned within the oil sump or reservoir 199 formed by the cylinder block 110 and the crankcase cover 195.

The connections between the cylinder block 110 and the cylinder head 125 and between the engine block 105 and the crankcase cover 195 provide locations for possible leaks (e.g., of air, fuel-air mixture, oil, etc.) into or out of the engine block 105. Also, the locations at or near these connections, particularly between the cylinder block 110 and the cylinder head 125 (e.g., at the mounting locations 135, 140) require a substantial mass of material in order to make the connection. The substantial mass is necessary to minimize potential adverse effects of the clamping force needed to secure the cylinder head 125 to the cylinder bock 110. The shape and mass of the material used in the mounting locations 135, 140 is, at least in part, determined by the need to minimize or control the amount of distortion caused to the cylinder bore 120 when the cylinder head 125 is bolted to the cylinder block 110. Such distortion (e.g., of the roundness and/or eccentricity of the cylinder bore 120) can result in leaks into or out of the cylinder bore 120 (e.g., to or from the crankcase 115).

The substantial mass of the mounting locations 135, 140 also can cause failure modes related to heat transfer at these locations. For example, thermal expansion at and near the mounting locations 135, 140 and the sealing surfaces of the cylinder block 110 and the cylinder head 125 during use of the engine 100 and the subsequent cooling of these areas when the engine 100 is stopped may result in a reduced clamping force between the cylinder block 110 and the cylinder head 125 (e.g., due to stretched bolts 155 causing a “loose” cylinder head 125). This reduced clamping force may result in the head gasket 130 being unable to maintain a good seal and allowing leaks past the head gasket 130. Air leaks into the cylinder bore 120 increase combustion gas temperatures, which may cause the engine 100 to overheat. In some cases, the overheating may cause distortion of the cylinder block 110 (e.g., of the cylinder bore 120). As another example, difficulty in cooling the substantial mass of the mounting locations 135, 140 and/or the locations around the valves 170, 180 may result in distortion of the cylinder bore 120 and/or loosening or dislodging a valve seat insert due to excessive temperature variations. When the engine 100 is running hotter than normal engine temperatures, the cylinder bore 120 expands and may distort (e.g., near the exhaust valves). Distortion of the cylinder bore 120 may prevent the piston rings from forming a proper seal, thereby providing combustion gases a path to the crankcase. Distortion of the cylinder bore 120 near a valve 170, 180 may cause the valve seat 185, 190 to loosen or dislodge due to differences between thermal expansion of the portion of the cylinder block 110 surrounding the valve seat and of the valve seat 185, 190 itself

Eliminating bolted connections or other fastened connections between the cylinder block 110 and the cylinder head 125 and between the engine block 105 and the crankcase cover 195 would help to reduce failure modes related to clamping forces, thermal expansion, and leaks between these components and allow reduction in the substantial mass of material needed at these locations to allow for bolted connections. Welded connections between the cylinder block 110 and the cylinder head 125 and between the engine block 105 and the crankcase cover 195 would help to reduce the shortcomings of the bolted connections. However, aluminum, which is a preferred material for engine blocks, cylinder heads, and crankcase covers, can be difficult to weld.

Advances in aluminum die-casting allow for die-cast engine blocks, cylinder heads, and crankcase covers having material properties suitable for welding. In particular, the hydrogen gas porosity of the aluminum must be reduced in order to allow welding. In some embodiments, aluminum (e.g., die-cast aluminum) is capable of being welded when the gas porosity of the cast aluminum is 0.30 milliliters per 100 grams of aluminum or less. In other embodiments, gas porosity of the cast aluminum is 0.15 milliliters per 100 grams of aluminum or less. Using the E505 ASTM standard for casting priority, levels 1 or 2 are preferred, with level 4 also likely to be acceptable. Level 5 is not believed to be acceptable.

Gas porosity can be reduced by melting the aluminum covered by an inert gas, in an environment of low-solubility gases (e.g., argon, carbon dioxide, etc.) or under a flux that prevents contact between the aluminum and air. Gas porosity can be reduced in several ways during the casting process. Turbulence from pouring the liquid aluminum into a mold can introduce gases into the molten aluminum, so the mold may be designed to minimize such turbulence. Advances in electronic control of the casting process, particularly for die casting, allow for relatively slow injection of molten aluminum into the die and finite control of the injection process, which results in cast aluminum having relatively low levels of gas porosity. Additionally, various vacuum die-casting techniques in which a vacuum is drawn in the mold prior to and/or during injection of the molten aluminum into the mold may result in cast aluminum having relatively low levels of porosity.

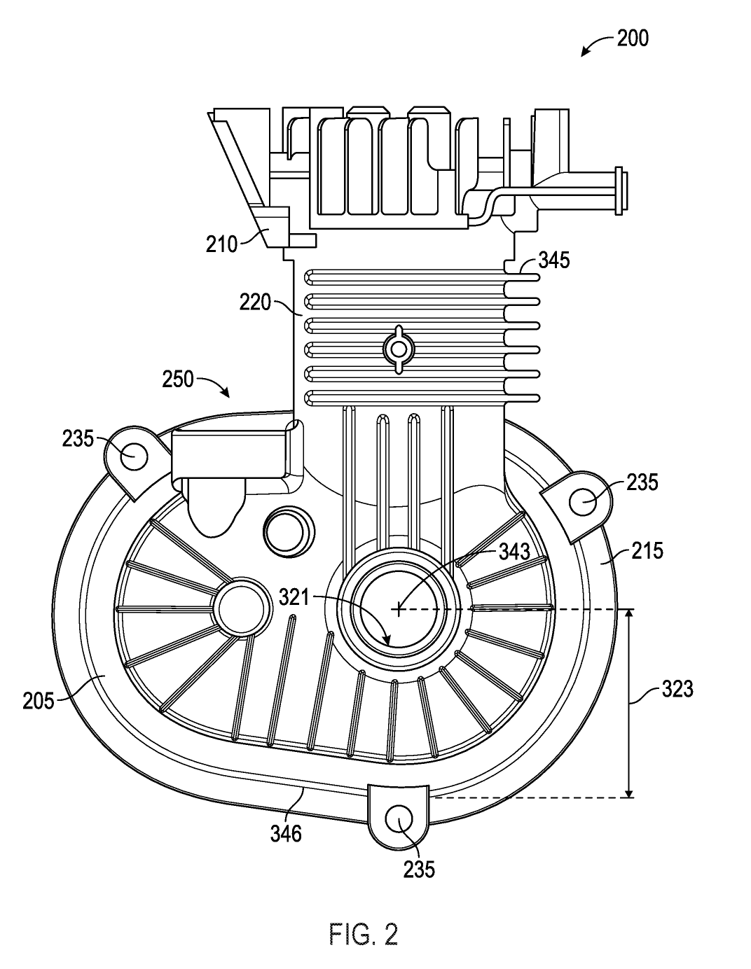

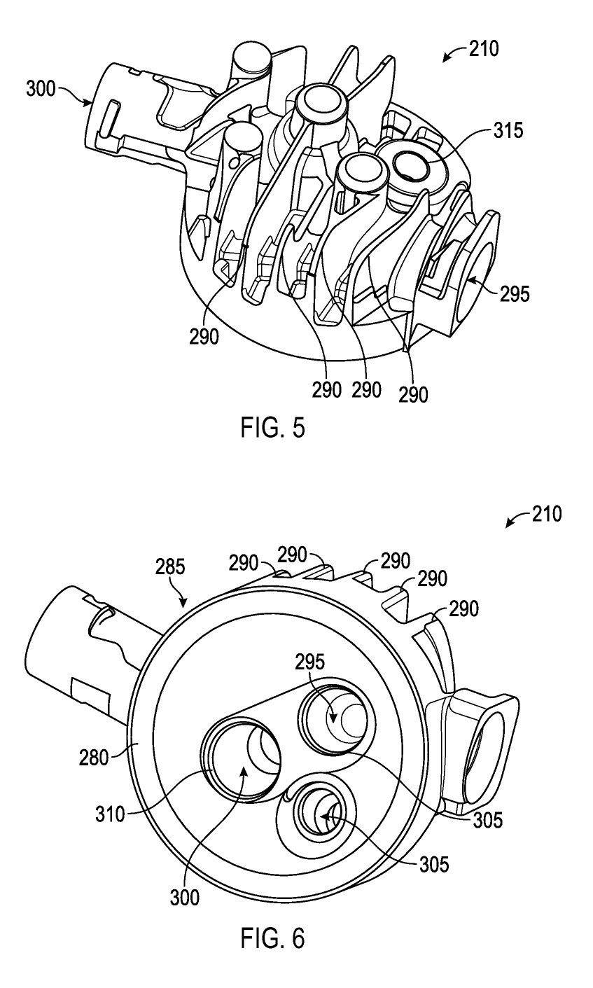

Referring to FIGS. 2-6, structural components of a small air-cooled internal combustion engine 200 that can be used in either a vertically-shafted orientation or a horizontally-shafted orientation are illustrated. According to an exemplary embodiment, the engine 200 is a single-cylinder, air-cooled, four-stroke engine. However, in other embodiments, the engine may have other configurations. For example, the engine may have two or more cylinders; the engine may have a slant bore; or the engine may have a V configuration, or other appropriate cylinder configuration. The engine 200 can be used on a variety of end products, including outdoor power equipment, portable jobsite equipment, and standby or portable generators. Outdoor power equipment includes lawn mowers, riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, etc. Outdoor power equipment may, for example, use the engine 200 to drive an implement, such as a rotary blade of a lawn mower, a pump of a pressure washer, an auger of a snow thrower, and/or a drivetrain of the outdoor power equipment. Portable jobsite equipment includes portable light towers, mobile industrial heaters, and portable light stands.

The engine 200 includes an engine block 205, a cylinder head 210, and a crankcase cover 215. The cylinder head 210 is welded to the engine block 205 and the crankcase cover 215 is welded to the engine block 205. In some embodiments, these components are laser welded to one another. In other embodiments, these components are friction-stir welded to one another. In other embodiments, these components are MIG or TIG welded to one another. In other some, the crankcase cover 215 is welded to the engine block 205 and the cylinder head 210 is welded to the engine block 205. In other embodiments, the crankcase cover 215 is welded to the engine block 205 and the cylinder head 210 is fastened to the engine block 205 by other means (e.g., bolted, fastened by adhesive, etc.).

Welding these connections eliminates the possible leak points at these connections. Eliminating these possible leak points results in the engine 200 consuming less oil and operating at a lower oil temperature than standard small air-cooled engines. The welded connections between the cylinder head 210 and the engine block 205 and between the crankcase cover 215 and the engine block 205 may be similar to those described in U.S. Utility patent application Ser. No. 14/569,020, filed Dec. 12, 2014, which is incorporated herein by reference in its entirety.

The engine block 205 includes a cylinder block 220. The cylinder block 220 includes one or more cylinder bores 225, each receiving a piston 320. A cylinder wall 230 has a cylinder wall thickness. In some embodiments, the cylinder wall thickness is substantially constant. An end face or mounting surface 240 of the cylinder block 220 is configured to mate with (e.g., engage, abut) the cylinder head 210 so that the cylinder head 210 may be welded to the cylinder block 220. One or more cooling fins 245 extend from the outer surface of the cylinder wall 230. In some embodiments, the cooling fins 245 surround all 360° of the cylinder wall 230. In other embodiments, the cooling fins cover less than 360° of the cylinder wall 230 (e.g., 330°, 315°, 300°, 270°, etc.). The crankcase cover 215 includes apertures 235 configured to receive a threaded fastener to couple the engine 200 to the equipment powered by the engine via a standard garden mounting flange. A mounting bracket may be attached to the apertures 235 to mount the engine to a standard garden mounting flange for a horizontally-shafted engine.

The piston 320 is coupled to a crankshaft 325 with a connecting rod 330 to convert translation of the piston 118 to rotation of the crankshaft 325. A crankshaft opening or aperture 321 is formed through the engine block 205 to allow the crankshaft 325 to pass through the engine block 205. The engine 200 may include a camshaft 340 driven by a geared connection between a camgear 345 and a timing gear coupled to the crankshaft 325. In some embodiments, the camshaft 340 drives push rods to operate intake and exhaust valves that direct fuel and air flow through the combustion chamber, where combustion processes interact with the piston 320. Two push rod openings 250 are formed in the engine block 205 to allow each push rod to extend from the camshaft to a rocker arm. A push rod housing may be secured and sealed to the engine block 205. The push rod housing surrounds and protects the push rods. In some embodiments, the push rod housing is formed of plastic with overmolded gaskets (e.g., rubber gaskets) at the connection points between the housing and the engine block 205 and the valve cover. In some embodiments, the gaskets are formed in other appropriate ways and/or from other appropriate materials.

According to an exemplary embodiment, as the piston 320 translates back and forth, the connecting rod 330 rotates the crankshaft 325. Counterweights (e.g., counterbalances) 350, reduce wobble of the crankshaft 325 as the connecting rod 330 drives the crank throw (e.g., a measure of the distance the piston 320 and connecting rod 330 travel). The internal volume of the engine block 205 is sized to allow the piston 320 to translate and for the crankshaft 325, the camshaft 340, and the camgear 345 to rotate freely.

Oil is collected inside an oil sump or reservoir 347 formed by the engine block 205 and the crankcase cover 215 for distribution within the engine to lubricate moving components, including the piston 320, the crankshaft 325, the camshaft 340, and the camgear 345. The engine 200 does not include a mechanical governor positioned within the oil reservoir 347 and instead includes an electronic governor 400. Eliminating the mechanical governor allows for a reduction in volume of the oil reservoir 347 as compared to engines including a mechanical governor (e.g., the engine 100 described above). This reduction in volume changes the geometry of the engine block 205.

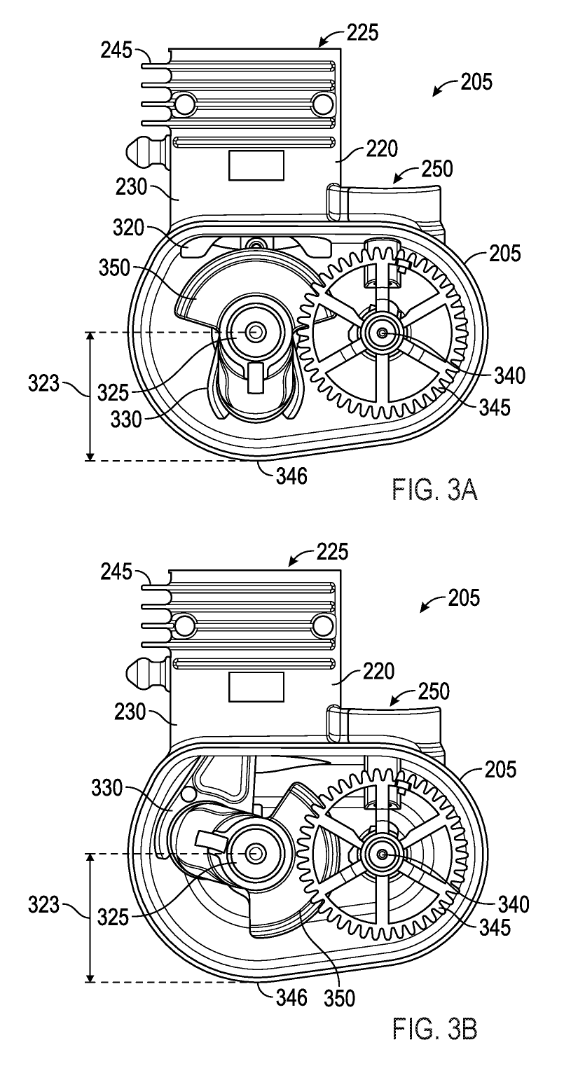

As shown in FIGS. 2-3B, the distance 341 between the between the center 343 of the crankshaft opening 321 (where the center 343 lies on the axis of rotation of the crankshaft 325) and at least a portion (an edge or other end point) of the outer surface 346 of the engine block is less than the standard minimum distance between the crankshaft axis and the horizontal mounting surface for a standard garden mounting flange for a horizontally-shafted engine. The distance 341 is measured radially outward from the center 343 to of the outer surface 346 of the engine block, not axially along the crankshaft's axis of rotation. The standard minimum distance is 4.25 inches for engines rated less than 6 horsepower. The standard minimum distance is 5.25 inches for engines rated 6 horsepower and above. By spacing an edge of the outer surface 346 the distance 341 away from the center 343 of the crankshaft opening 321, the geometry of the engine block 205 is such that the engine block itself will not physically prevent the engine 200 from being properly mounted in a horizontally-shafted orientation. The distance 341 ensures the necessary clearance between the outer surface 346 and the horizontal mounting surface. In a standard small air-cooled engine like engine 100 illustrated in FIG. 1, no edge of the outer surface of the engine block is less than the distance 341 and the physical structure of the engine block prevents the engine from being properly mounted in a horizontally-shafted orientation to a standard garden mounting flange for a horizontally-shafted engine. The length of the edge spaced apart from the center 343 may vary in different embodiments of the engine, but is sufficient to allow proper mounting in a horizontally-shafted orientation. The length of the edge may subtend an angle of at least 30 degrees between the center 343 and the ends of the length of the edge (e.g., 30 degrees, 45 degrees, 60 degrees, 75 degrees, 90 degrees, etc.). As illustrated in FIGS. 2-3B, the edge is located opposite the cylinder bore 225 and the length of the edge subtends an angle of at least 30 degrees. Other locations for the edge are possible, including for a slant bore or two cylinder engines. The engine 200 is able to be mounted in a vertically-shafted orientation via the apertures 235 of the crankcase cover 215.

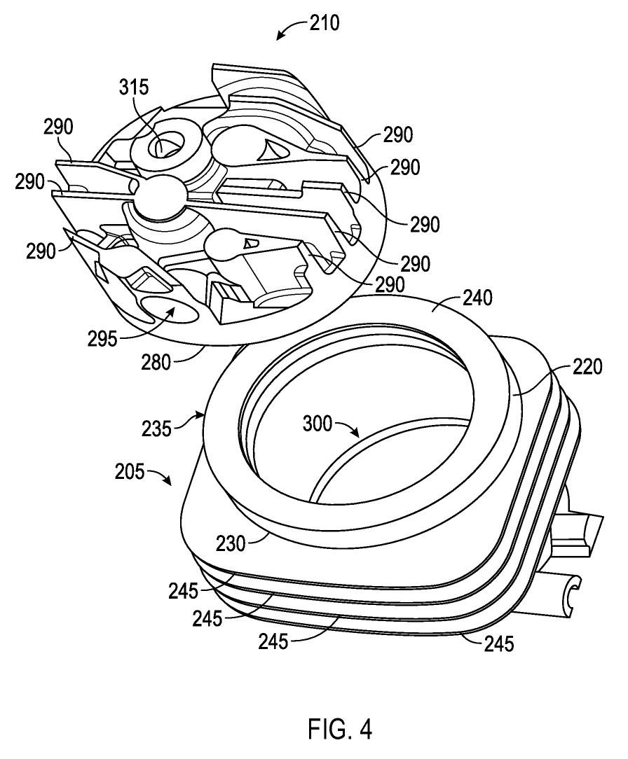

Referring to FIGS. 4-6, the cylinder head 210 includes an end face or mounting surface 280 having a cylinder wall thickness 285. In some embodiments, the cylinder wall thickness 285 is substantially constant. The mounting surface 280 is configured to mate with (e.g., engage, abut) the mounting surface 240 of the cylinder block 220 so that the cylinder head 210 may be welded to the cylinder block 220. The cylinder head 210 also includes one or more cooling fins 290. An intake port 295 and an exhaust port 300 are formed in the cylinder head 210. A valve seat is secured to the bottom of the cylinder head 210 at a valve seat mounting location 305, 310 around an aperture (e.g., opening) to each of the intake port 295 and the exhaust port 300. In some embodiments, the valve seats are welded to the cylinder head 210 (e.g., laser welded, friction welded, MIG welded, TIG welded). An aperture or opening 315 for receiving a spark plug is also formed in the cylinder head 210.

The mounting surfaces 280 and 240 of the cylinder head 210 and the cylinder block 220 may be configured such that the cylinder head 210 may be coupled to the cylinder block 220 with multiple orientations. For example, the mounting surfaces 280 and 240 may be configured such that the cylinder head 210 may be coupled to the cylinder block 220 at multiple discreet locations (e.g., four locations at 90° intervals) or may be configured such that the cylinder head 210 may be coupled to the cylinder block 220 at any orientation. In this way, the cylinder head 210 may be coupled to the cylinder block 220 in such a way to advantageously orient features, such as the intake port 295 and the exhaust port 300.

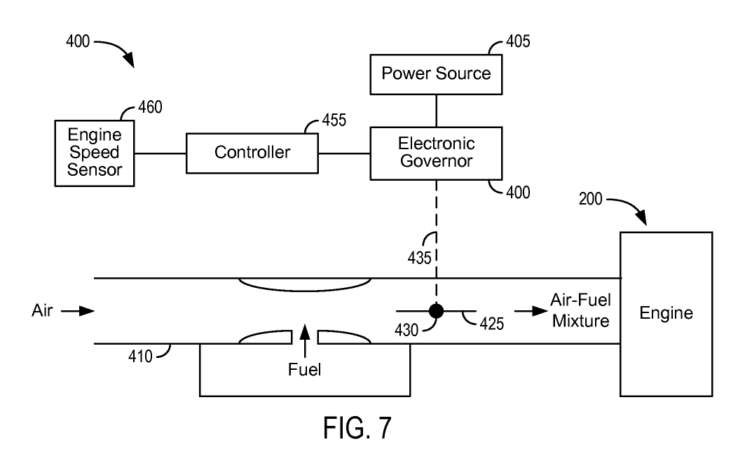

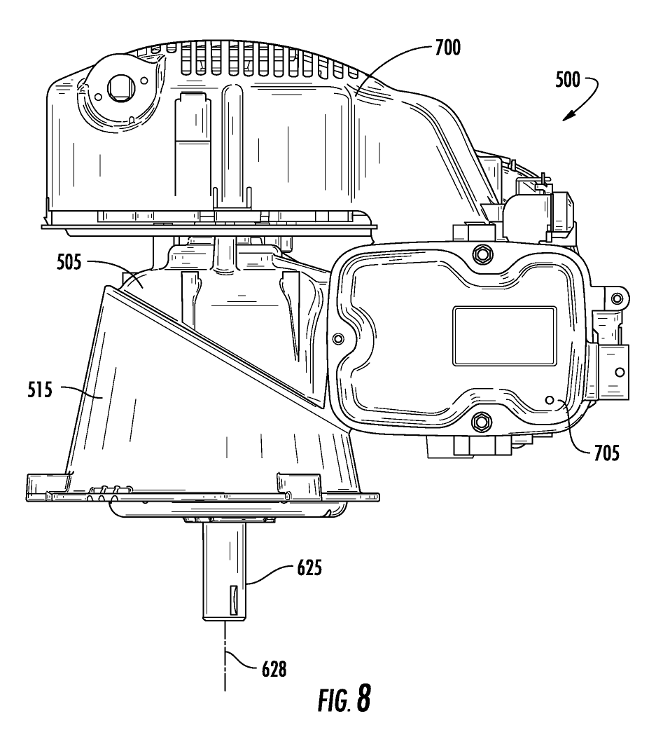

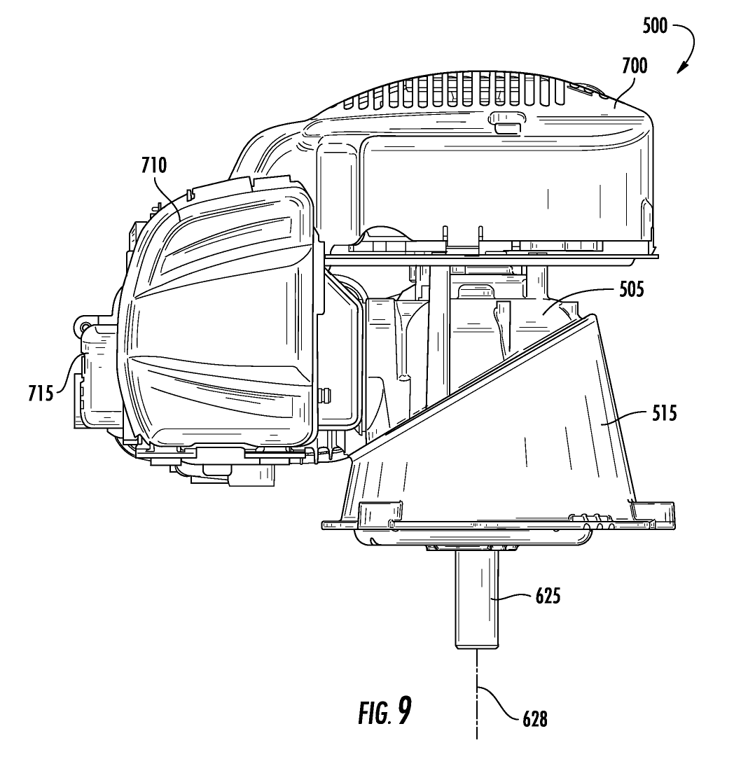

Referring to FIG. 7, the electronic governor 400 is illustrated according to an exemplary embodiment. The electronic governor 400 controls the speed of the engine 200 by controlling the position of a throttle valve 425 of a carburetor 410. In some embodiments, the electronic governor 400 is coupled to the throttle valve 425 by a throttle lever 430 and a linkage 435. In the carburetor 410, fuel is mixed with air to produce an air/fuel mixture for combustion in one or more cylinders of the engine 200. The throttle valve 425 controls the flow of the air/fuel mixture out of the carburetor 410 and in doing so controls the speed of the engine 200.

The electronic governor 400 is used to control the position of the throttle valve 425, thereby controlling the engine speed. The throttle valve 425 is movable between a closed position and a wide-open position. The position of the throttle valve 425 is adjusted so that the engine speed is maintained at a desired engine speed (e.g., the governed speed or the target engine speed). The desired engine speed can be a constant or can be varied controller in response to inputs from the engine (e.g., inputs related to engine load, desired output, or other engine operating conditions or objectives like providing an idle down operating mode in which the engine speed is lower when no load is applied to the engine than the operating engine speed when a load is applied to the engine).

An electrical power source 405 provides electrical power to the electronic governor 400 and other components (e.g. the controller 455). In some embodiments, the electrical power source 405 is a battery (e.g., a 12V battery, a lithium-ion battery, etc.) or other device that provides power to other components and systems of the engine or the vehicle or equipment powered by the engine 200. In some embodiments, the electronic governor 400 may have a dedicated electrical power source 405, such as a thermoelectric generator. A thermoelectric generator may be provided in a location such that one side is exposed to a relatively high temperature (e.g., near the engine block 205 to capture waste heat from the engine 200) and the opposite side is exposed to a relatively cool temperature (e.g., the surrounding air).

A controller 455 controls operation of the electronic governor 400. In some embodiments, the controller 455 also controls the operation of other components of the engine 200. An engine speed sensor 460 is coupled to the controller 455 to provide an engine speed input to the electronic governor 400. In some embodiments, the engine speed sensor 460 detects the engine speed using an ignition signal from an ignition system. For example, the positive sparks or pulses from the ignition system could be counted and used to determine the engine speed. In other embodiments, other appropriate engine speed sensors are utilized, such as a Hall-effect sensor that detects a magnet on the flywheel or other rotating component of the engine.

The controller 455 may include processing circuit, an input interface, and an output interface. The processing circuit includes a processor and memory. The processing circuit and processor are configured to receive inputs from an input interface (e.g., via a wired or wireless communication link with other components of the engine) and to provide an output (e.g., a control signal, an actuator output, etc.) via an output interface (e.g., via a wired or wireless communication link other components of the engine). The processing circuit can be a circuit containing one or more processing components (e.g., the processor) or a group of distributed processing components. The processor may be a general purpose or specific purpose processor configured to execute computer code or instructions stored in the memory or received from other computer readable media (e.g., CDROM, network storage, a remote server, etc.). The processing circuit may also include the memory. Memory may be RAM, hard drive storage, temporary storage, non-volatile memory, flash memory, optical memory, or any other suitable memory for storing software objects and/or computer instructions. When the processor executes instructions stored in the memory for completing the various activities described herein, the processor generally configures the computer system and more particularly the processing circuit to complete such activities. The memory may include database components, object code components, script components, and/or any other type of information structure for supporting the various activities described in the present disclosure. For example, the memory may store data regarding the operation of a controller (e.g., previous setpoints, previous behavior patterns regarding used energy to adjust a current value to a setpoint, etc.). According to an exemplary embodiment, the memory communicably connected to the processor and includes computer code for executing one or more processes described herein and the processor is configured to execute the computer code.

Welding the cylinder head 210 to the engine block 205 eliminates the need for a head gasket (e.g., the head gasket 130). A head gasket is porous. During operation of an engine, oil is trapped in the pores of the head gasket (e.g., the gasket wicks oil from the cylinder bore into the gasket). This trapped oil is burned off during operation of the engine. Eliminating the head gasket eliminates this source of oil loss due to oil burn off, thereby reducing oil consumption, and improves emissions by eliminating this source of burnt oil. Despite being optimized to allow heat transfer therethrough, the head gasket acts as an insulator between the cylinder block and the cylinder head. Eliminating the head gasket therefore improves heat transfer between the cylinder block and the cylinder head by eliminating the insulative effect of the head gasket. Eliminating the head gasket also eliminates the need to service or replace the head gasket.

Welding the cylinder head 210 to the engine block 205 also eliminates cylinder bore distortion caused by the clamping force applied by the bolts used in a bolted connection between the cylinder block and the cylinder head in a standard small air-cooled engine (e.g., the engine 100).

Welding the cylinder head 210 to the engine block 205 allows the structure (e.g., the shape and mass) of these connections to be modified to utilize less material (e.g., less mass) than standard small air-cooled engines (e.g., the engine 100). This helps to reduce thermal distortion related to the substantial mass found at or near these connections in standard small air-cooled engines. The mass of material needed at this connection may be reduced (e.g., by eliminating the mounting locations 135, 140 of the engine 100). This reduction in material allows for an increase in the surface area of the external cooling fins (e.g., the cooling fins 245), by allowing the cooling fins to extend fully around the exterior of the cylinder bore, as opposed to the truncated cooling fins typically found on standard small air-cooled engines (e.g. the engine 100). The reduction in material and increased cooling fin surface area also reduces the thermal expansion as this connection, thereby reducing the likelihood of failure modes associated with thermal expansion. The reduction in material improves temperature distribution throughout the cylinder block and cylinder head assembly, thereby reducing hot spots during operation of the engine. The reduction in material also reduces cost and weight of the engine block and the cylinder head. In some embodiments, the reduction in material results in an engine that uses 1.3 pounds less aluminum than a standard small air-cooled engine. In some embodiments, the material used for the cylinder head is reduced by about 50%. The reduction in material also allows inlet port of the cylinder head to be positioned closer to the periphery of the cylinder head than in a cylinder head for a standard small air-cooled engine. This positioning of the inlet port keeps the incoming air cooler and more dense relative to a standard small air-cooled engine. Welding the cylinder head 210 to the engine block 205 allows for the elimination of push rod guide tubes from the engine block and allows for use of external guide tubes (e.g., the push rod housing 260). Eliminating the push rod guide tubes from the engine block removes the need for the material surrounding the guide tubes and allows for greater flexibility in the placement of the valve ports in the cylinder head.

Welding the crankcase cover 215 to the engine block 205 eliminates the need for a crankcase gasket (e.g., the crankcase gasket 197). This provides similar advantages to welding the cylinder head 210 to the engine block 205, including eliminating a possible leak point and reducing the amount of material used at this connection. Welding the crankcase cover 215 to the engine block 205 also allows for the elimination of the lubricant inlet or oil fill tube for providing oil to the crankcase and the dipstick that is typically inserted into the oil fill tube to both seal the tube and provide a user with an indication of the oil level in the crankcase. Eliminating these components reduces manufacturing and supply costs because the oil fill tube does not need to be formed and the dipstick does not need to be provided.

Welding the cylinder head 210 to the engine block 205 and welding the crankcase cover 215 to the engine block 205 allows for the engine 200 or the engine block 205 to be “substantially sealed.” Such a “substantially-sealed engine” or “substantially-sealed engine block” does not include a head gasket, does not include a crankcase gasket, or does not include both a head gasket and a crankcase gasket. A “substantially-sealed engine” or a “substantially-sealed engine block” may include some gaskets like a valve cover gasket sealing the valve cover to the cylinder head, an exhaust gasket sealing an exhaust pipe or muffler to the exhaust port, and/or gaskets sealing the push rod tubes (e.g., push rod tubes 265, 270) to the engine block and cylinder head, but the cylinder bore and the crankcase are permanently sealed (e.g., not accessible without destructively opening the cylinder bore and/or the crankcase). A substantially-sealed engine or engine block reduces user maintenance by eliminating or reducing the need to change the oil in the engine 200. In some embodiments, the oil in the engine 200 is never changed. A substantially-sealed engine can be filled with oil at the factory or dealer and then sealed, eliminating the possibility of a user not filling the engine with oil before starting the engine for the first time. The engine oil does not need to be changed because the possible leak points have been eliminated and the engine is able to operate at a lower engine oil temperature. The lower temperature slows or prevents oil breakdown as compared to standard small air-cooled engines (e.g., the engine 100).

Because the engine 200 or the engine block 205 is substantially sealed by the welding of the cylinder head 210 to the engine block 205 and the welding the crankcase cover 215 to the engine block 205 and the engine speed is controlled with the electronic governor 400, the mechanical governor, as well as components of the engine 200 associated with the maintenance of the oil may be eliminated, including the dipstick and the oil fill tube.

The reduced size of the engine 200 provides several benefits. The smaller size of the engine 200, as well as the substantially sealed engine block 205 allows the engine 200 to be oriented in either a vertical crankshaft orientation or a horizontal crankshaft orientation. The engine 200 may be oriented in a vertical crankshaft orientation for example, for a push lawnmower, a lawn tractor, or a pressure washer. The engine 200 may be oriented in a horizontal crankshaft orientation for example, for a log splitter, a generator, agricultural equipment, or a pressure washer.

Further, the smaller engine volume and lower weight can aid in the shipping and storage of the engine 200. The mass of the engine 200 may be substantially less than a conventional engine. For example, a standard sized shipping pallet may be capable of accommodating 120 of the engines 200, in comparison with only 96 conventionally constructed engines like the engine 100.

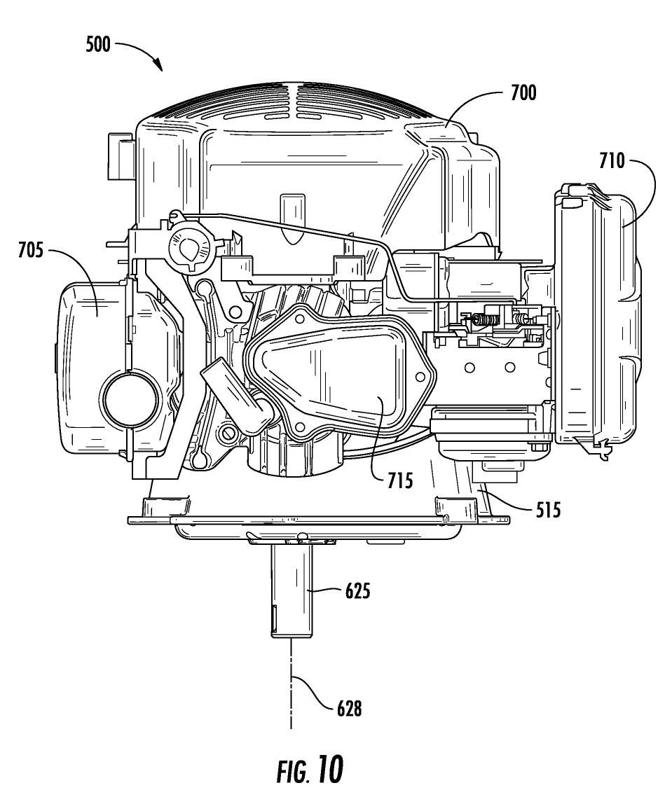

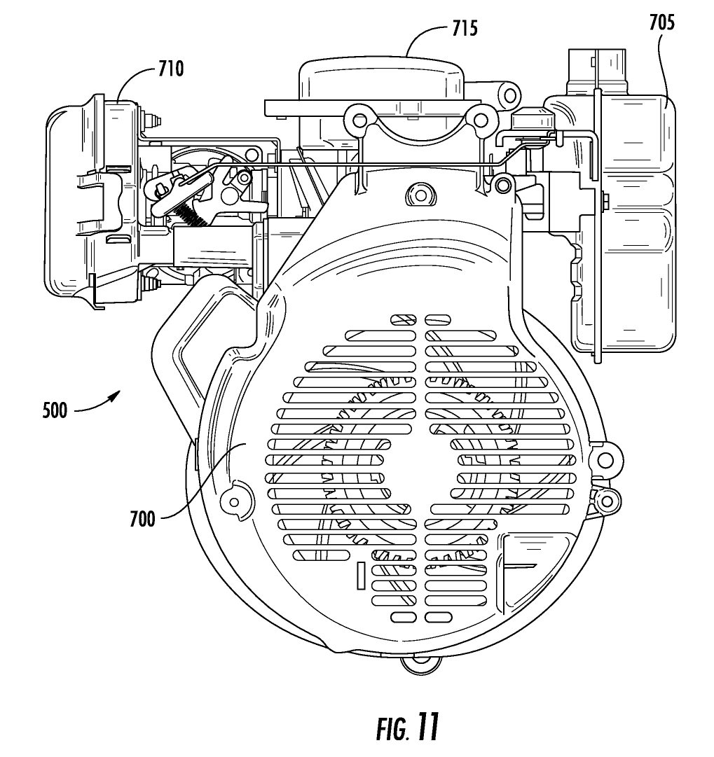

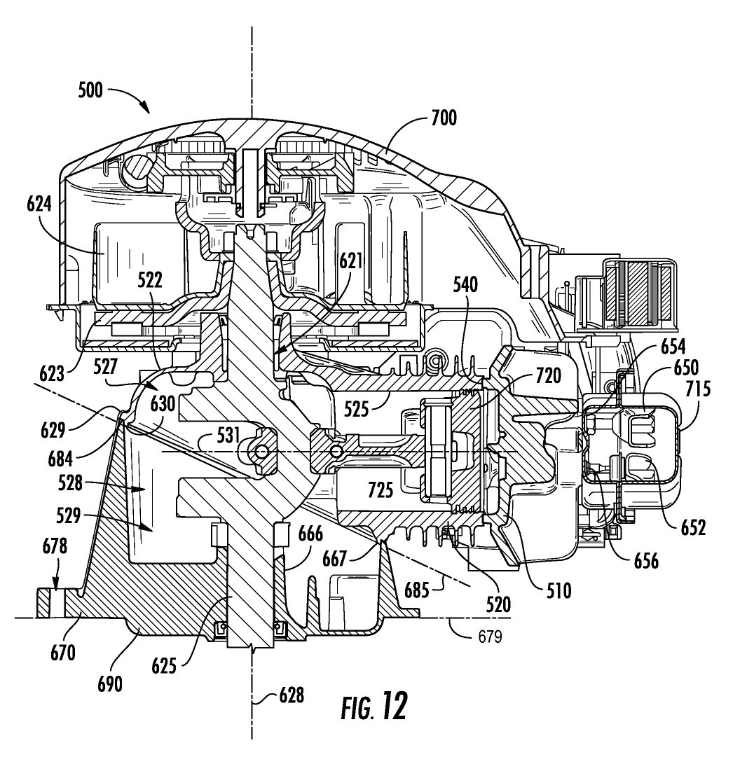

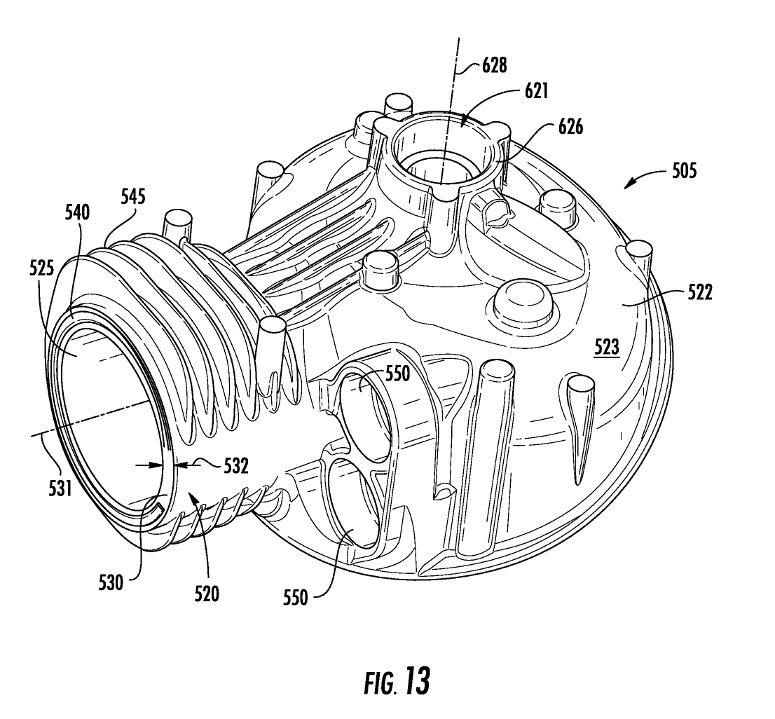

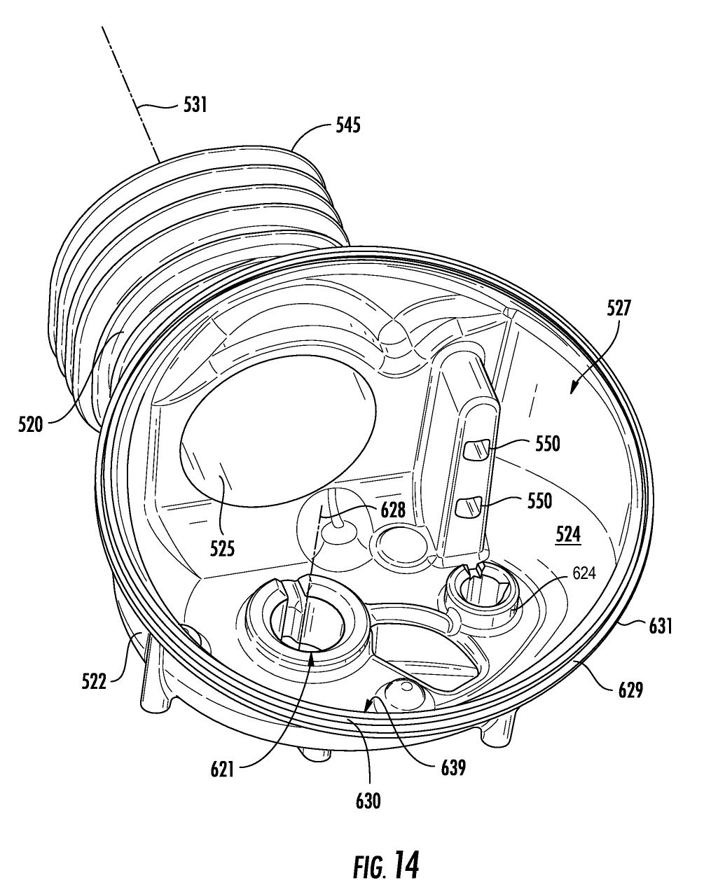

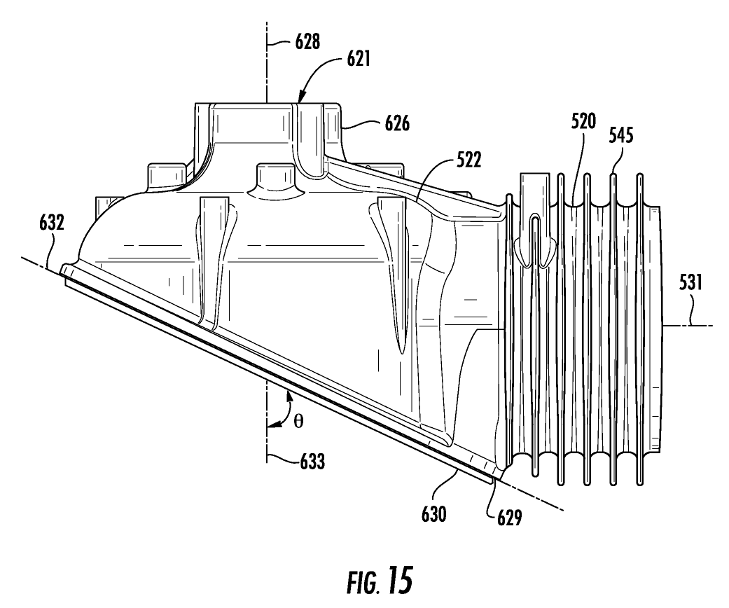

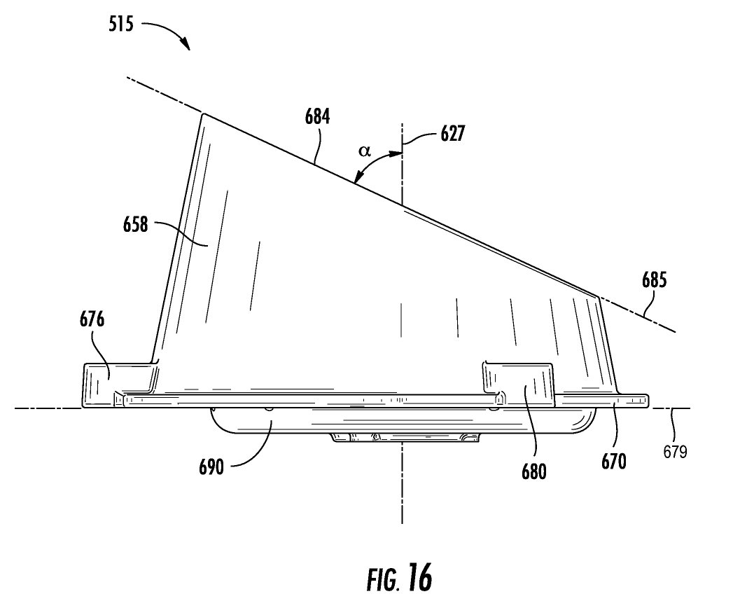

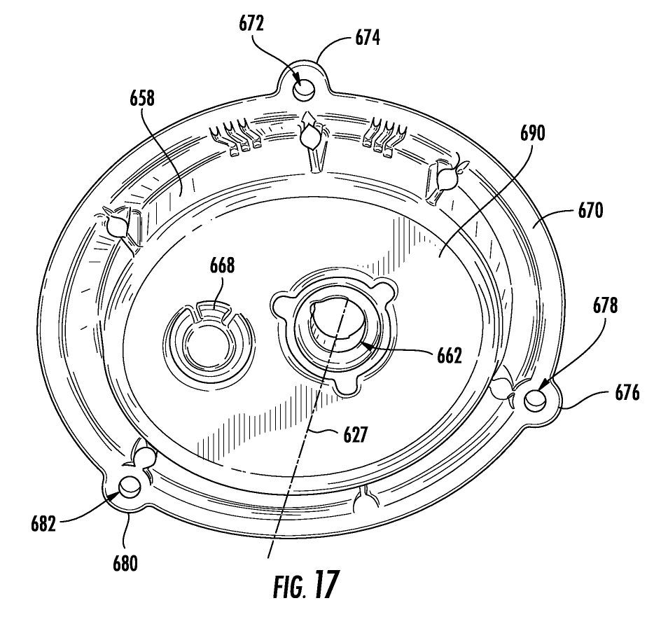

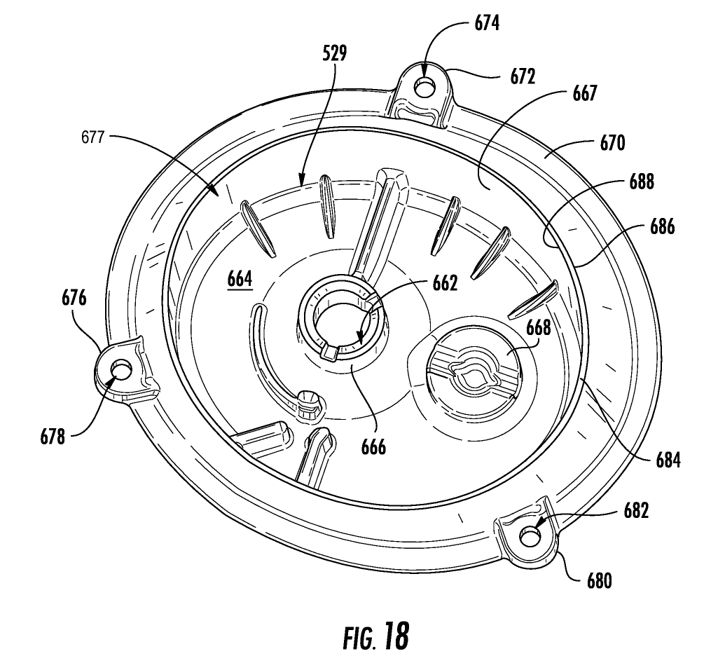

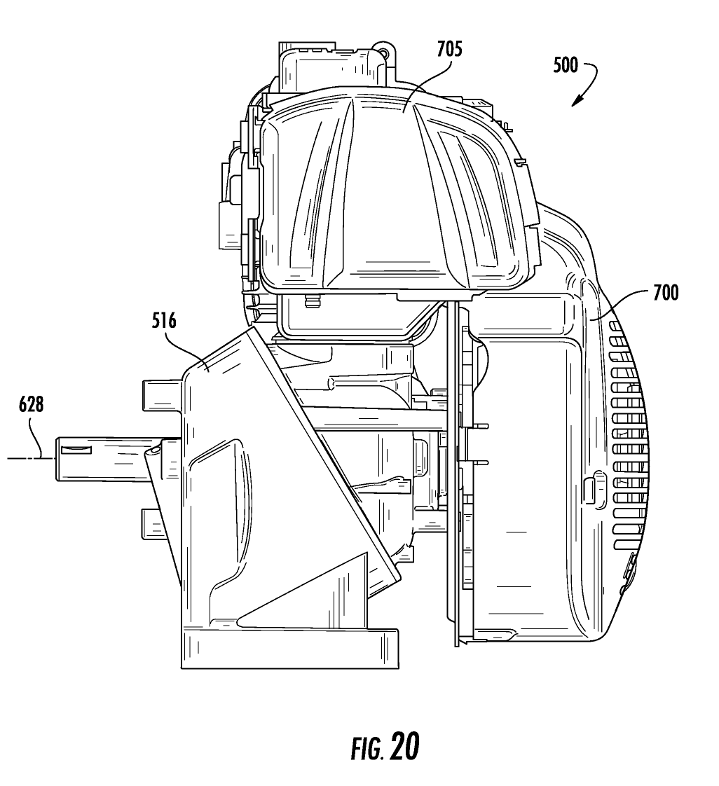

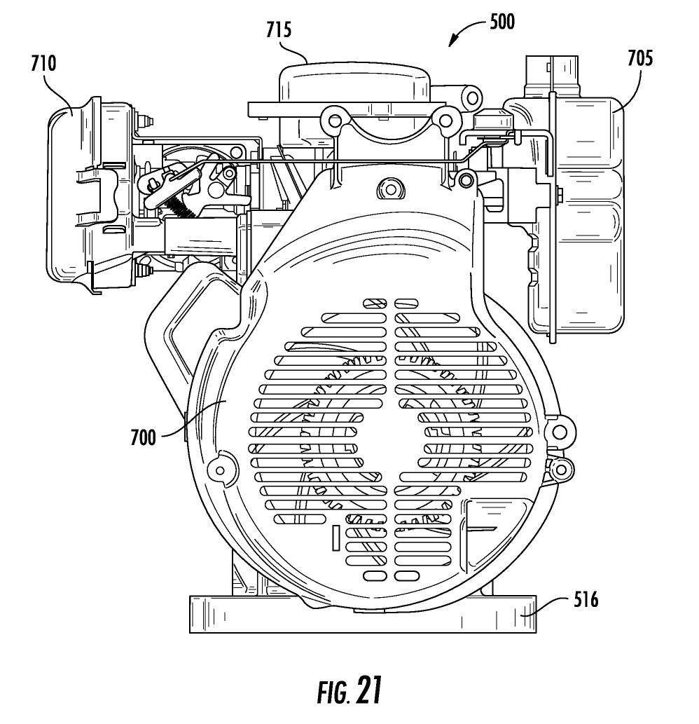

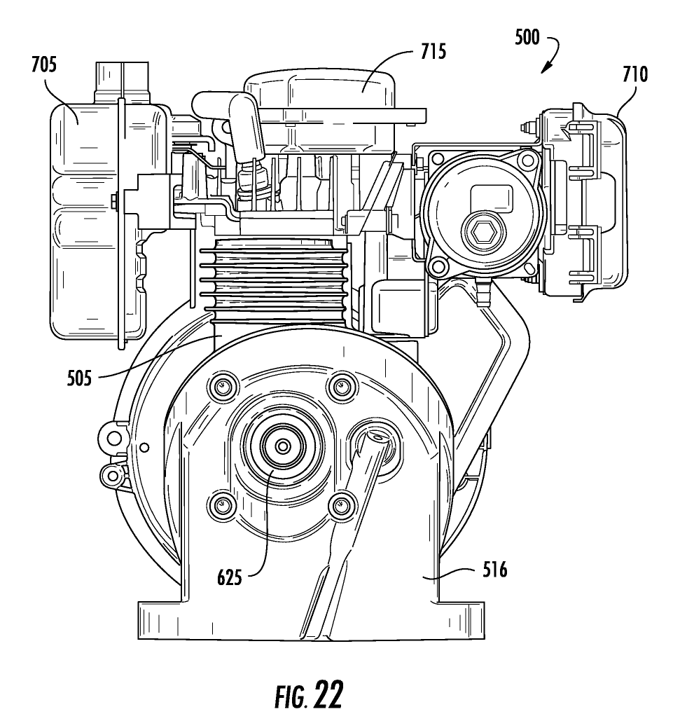

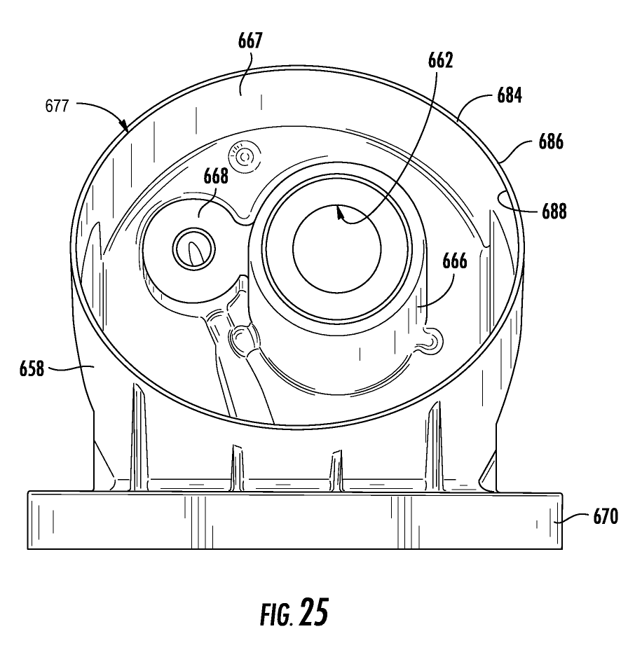

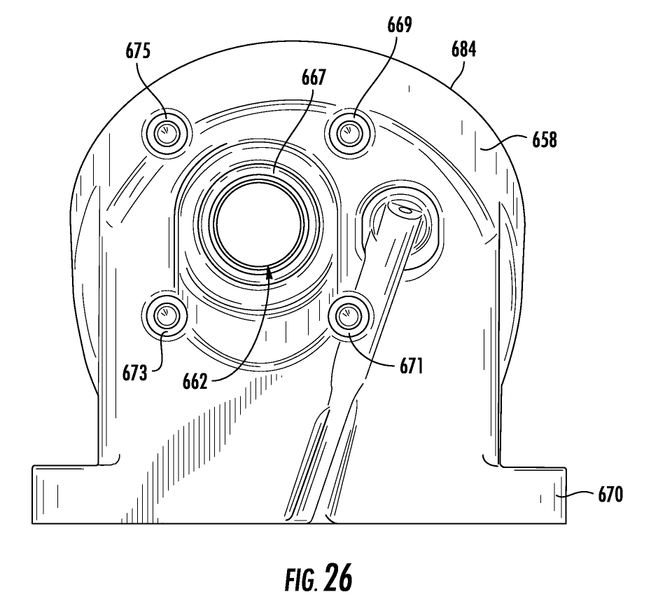

Referring to FIGS. 8-26, a small air-cooled internal combustion engine 500 including an engine block 505 that can be used in either a vertically-shafted orientation or a horizontally-shafted orientation are illustrated, according to an exemplary embodiment. In some embodiments, the engine 500 includes various features of the engines 200 described above. As illustrated, the engine 500 is a single-cylinder, air-cooled, four-stroke engine. However, in other embodiments, the engine may have other configurations. For example, the engine may have two or more cylinders; the engine may have a slant bore; or the engine may have a V configuration, or other appropriate cylinder configuration. As described above, the engine 500 can be used on a variety of end products, including outdoor power equipment, portable jobsite equipment, and standby or portable generators.

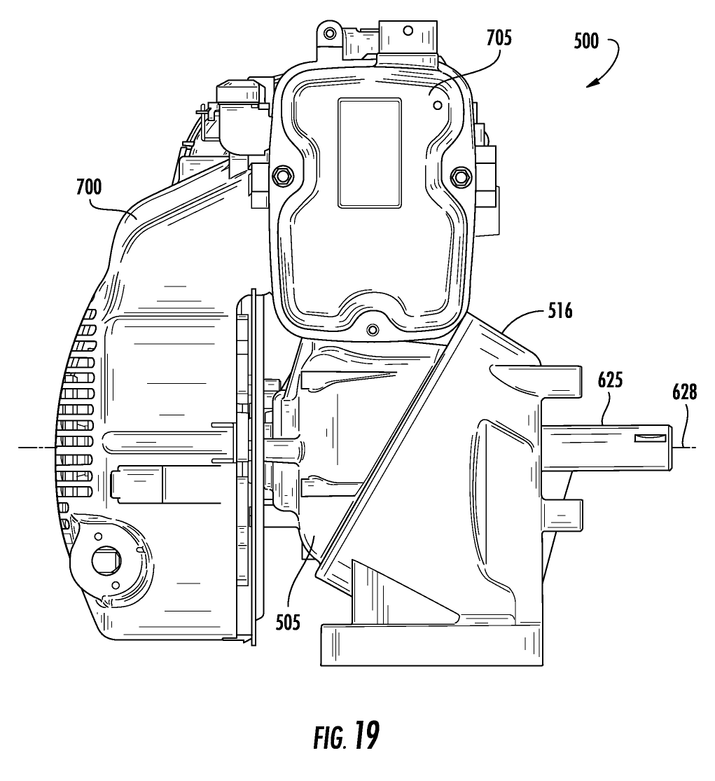

The engine 500 includes an engine block 505, a cylinder head 510, and a crankcase cover. A crankcase cover 515 for a vertical shaft engine is illustrated in FIGS. 8-12 and 16-18. A crankcase cover 516 for a horizontal shaft engine is illustrated in FIGS. 19-26. The crankcase cover selected for use with the engine block 505 allows the engine block 505 to be used in either a vertical shaft engine with crankcase cover 515 or a horizontal shaft engine with crankcase cover 516. The engine 500 also includes a blower housing 700 for directing cooling air over the engine block 505 and to protect various components of the engine, a muffler 705, and an air filter assembly 710 for filtering air used for combustion by the engine.

FIGS. 13-15 illustrate the engine block 505. The engine block 505 includes a cylinder 520 and a crankcase body 522 that defines a portion 527 of a crankcase chamber 528 (or reservoir or oil sump). The remaining portion 529 of the crankcase chamber 528 is defined by the crankcase cover. As illustrated, the engine block 505 includes a single cylinder 520. In other embodiments, the engine block 502 includes two or more cylinders. The cylinder 520 extends away from the crankcase body 522. As illustrated, the crankcase body 522 is generally dome shaped and includes an exterior surface 523 and an interior surface 524 that defines the portion 527 of the crankcase chamber 528.

The cylinder 520 includes a cylinder bore 525 defined by the interior surface of a cylinder wall 530 and configured to receive a piston 720. A connecting rod 725 connects the piston 720 to the crankshaft 625 so that combustion processes in the cylinder 520 cause the piston 720 to reciprocate and thereby rotate the crankshaft 625 about the crankshaft axis 628. The cylinder bore 525 extends along and defines a central longitudinal cylinder axis 531. The cylinder bore 525 opens into the portion 527 of the crankcase chamber 528. The cylinder wall 530 has a cylinder wall thickness 532 extending between the inner surface and the outer surface of the wall 530. In some embodiments, the cylinder wall thickness 532 is substantially constant. An end face or mounting surface 540 of the cylinder 520 is configured to mate with (e.g., engage, abut) the cylinder head 510 so that the cylinder head 510 may be attached to the cylinder 520 (e.g., by welding). One or more cooling fins 545 extend from the outer surface of the cylinder wall 530. In some embodiments, the cooling fins 545 surround all 360° of the cylinder wall 530. In other embodiments, the cooling fins cover less than 360° of the cylinder wall 230 (e.g., 330°, 315°, 300°, 270°, etc.).

The crankcase body 522 includes a crankshaft opening or aperture 621 that is formed through the crankcase body 522 to allow a crankshaft 625 to pass through the engine block 505 to drive a flywheel 623 and a fan 624. Flywheel 623 and fan 624 may be a single integral component or separate components. In some embodiments, fan 624 is not driven by crankshaft and is instead driven by an electric motor. A boss 626 extends from the outer surface 523 of the crankcase body 522 and surrounds the crankshaft opening 621. The boss 626 and the crankshaft opening 621 extend along and define a central longitudinal crankshaft axis 628. A camshaft support or bearing 635 extends from the interior surface 524 near the crankshaft opening 621 to support a camshaft for rotation. Two push rod openings 550 are formed in the crankcase body 522 near the cylinder 520 to allow a pair of push rods to extend from the camshaft to rocker arm 650 and 652 that actuate intake and exhaust valves 654 and 656, respectively. A valve cover or rocker cover 715 is removably attached to the cylinder head 510 to cover and protect the rocker arms 650 and 652 and valves 654 and 656. The camshaft is driven by a geared connection between a camgear and a timing gear coupled to the crankshaft 625. The camshaft drives the push rods to operate the valves 654 and 656 valves that direct fuel-air mixture and exhaust flow through the combustion chamber of the cylinder 520, where combustion processes interact with the piston 620 to cause the piston to reciprocate in the cylinder 520.

A mounting face or surface 629 is located around the outer periphery of the crankcase body 522 opposite the crankshaft opening 621 and the boss 626. A wall or flange 630 extends away from the mounting surface 629 so that the mounting surface 629 is arranged as a ledge that is outwardly open to an edge 631 at the outermost periphery of the crankcase body 622 and bounded on the interior by a stop formed by the flange 630. In the illustrated embodiment, the outer surface of the flange 630 is parallel to the crankshaft axis 628. The mounting surface 629 defines a plane 632 that is angled at angle θ relative to a plane 633 that includes the crankshaft axis 628. In some embodiments, the plane 633 also includes the cylinder axis 531. When the mounting surface 629 is viewed in a direction orthogonal to the plane 632, the mounting surface 629 is annular (bounded by the flange 630 and the edge 631) and the edge 631 is substantially circular in shape. In the illustrated embodiment, the height of the flange 630 is less than the width of the mounting surface 629. In other embodiments, the relative length of the flange 630 and the mounting surface 629 may vary. The edge located along the interior and top surfaces of the wall 630 defines an opening 634 that opens to the portion 527 of the crankcase chamber 528. The mounting surface 629 is sized and shaped to mate with a corresponding mounting surface of the crankcase cover. Features that are common to the vertical shaft crankcase cover 515 and the horizontal shaft crankcase cover 516 that can be used with the engine block 505 will be described with the same reference numerals.

Referring to FIGS. 8-12 and 16-18, a crankcase cover 515 for a vertical shaft engine is illustrated according to an exemplary embodiment. The crankcase cover 515 includes a crankshaft opening or aperture 662 that is formed through a cover body 658 to allow the crankshaft 625 to pass through the crankcase cover 515 to drive an implement. The implement may be a blade, auger, alternator, pump, transmission, or other working component of the equipment powered by the engine 500. A boss 666 extends from an inner surface 664 of the cover body 658 and surrounds the crankshaft opening 662. The boss 666 and the crankshaft opening 662 extend along and define a portion 627 of the crankshaft axis 628. A camshaft support or bearing 668 extends from the interior surface 664 near the crankshaft opening 662 to support a camshaft for rotation. The interior surface 664 that defines the portion 529 of the crankcase chamber 528.

A mounting face or surface 684 is located around the periphery of the cover body 658 opposite the crankshaft opening 621 and the boss 666. The mounting surface 684 is arranged between an outer edge 686 and an inner edge 688. The inner edge 688 defines an opening 677 that opens to the portion 529 of the crankcase chamber 528. The mounting surface 684 defines a plane 685 that is angled at angle α relative to a plane that includes the portion 627 of the crankshaft axis 628. When the mounting surface 684 is viewed in a direction orthogonal to the plane 685, the mounting surface 684 is annular (bounded by the outer edge 686 and the inner edge 688) and the edges 686 and 688 are substantially circular in shape. The mounting surface 684 is sized and shaped to mate with the corresponding mounting surface 629 of the engine block 505.

Typically, standard small air-cooled engines have engine block and crankcase cover mounting surfaces that are arranged at an angle of 90 degrees relative to the crankshaft axis (e.g., as shown in FIG. 1). This also typically results in the engine block and crankcase cover mounting surfaces being arranged parallel to the cylinder axis (e.g., as shown in FIG. 1). This arrangement results in standard small air-cooled engines not being able to use a common engine block for both vertical shaft and horizontal shaft version of the engine.

In contrast, the angle θ of the mounting surface 629 of the engine block 505 and the angle α of the mounting surface 684 of the crankcase covers suitable for use with the engine block 505 (e.g., the crankcase cover 515 and the crankcase cover 516) are arranged at the same angle, which is not 90 degrees, to allow a common engine block 505 to be used with different crankcase covers (e.g., the crankcase covers 515 and 516) to create both vertical and horizontal shaft versions of the engine 500. This arrangement also positions the mounting surfaces 629 and 684 at an angle (i.e., not parallel to) relative to the cylinder axis 531. Applicant has found that an angle θ and an angle α of 25 degrees is particularly suitable to allow the same engine block 505 to be used with different crankcase covers, for example to be used with either the vertical shaft crankcase cover 515 or the horizontal shaft crankcase cover 516. Being able to use either crankcase cover 515 or 516 with the same engine block 505 allows the engine manufacturer to have increased flexibility within the same engine platform. The common engine block 505 can be attached to either a vertical shaft crankcase cover 515 or a horizontal shaft crankcase cover 516 in response to the engine manufacturer's production demands. The common engine block 505 also eliminates the need for the engine manufacture to provide tooling for separate vertical shaft engine blocks and horizontal shaft engine blocks for the same engine platform. This saves on both tooling and product development costs. In other embodiments, the angle θ and the angle α have different values that enable the engine block 505 to be used with different crankcase covers. In some embodiments, the angle θ and the angle α are at least 5 degrees. Setting the angles θ and α at the same value allows the mounting surfaces 629 and 684 can be brought into contact with one another to properly position the engine block 505 and the selected crankcase cover relative to one another and to secure the engine block 505 and the selected crankcase cover to one another.

The crankcase cover 515 also includes a mounting flange or plate 670 for attaching the crankcase cover 515 and the engine 500 to the equipment driven by the engine 500. The flange 670 includes an outer surface that contacts a corresponding mounting location on the equipment. This outer surface defines a plane 679. The plane 679 is located substantially perpendicular to the crankshaft axis 628 and substantially parallel to the cylinder axis 531 so that the engine 500 is arranged as a vertical shaft engine when the mounting flange 670 is used to secure the crankcase cover 515 to the mounting location of the equipment to be powered by the engine. A projection 690 extends below the plane 679 (when the crankcase cover 515 is viewed in its normal operating position, for example in FIG. 12).

The mounting flange 670 includes a number of mounting locations, each having a through hole to allow a bolt or other fastener to pass through the mounting flange 670 to secure the crankcase cover 515 to the desired mounting location. As illustrated, the mounting flange includes a three mounting locations 672, 676, and 680 each with a hole 674, 678, and 682, respectively, arranged in a standard engine mounting pattern (e.g., a SAE or other industry standard for mounting small internal combustion engines). Engine mounting patterns are standardized so that engines produced by different engine manufactures can be mounted to equipment produced by different original equipment manufacturers (OEMs) without having to customize the mounting arrangement between the engine and the equipment. This allows an OEM to offer the same equipment with different engines from different manufacturers to meet the OEM's engine needs or the customer's engine needs.

The crankcase cover 515 is attached to the engine block 505 by inserting the wall 630 of the engine bock 505 into the opening 677 defined by the inner edge 688 of the cover body 658 so that the outer surface of the wall 630 contacts a portion of an interior wall surface 667 of the cover body 658. When properly positioned relative to one another the outer surface of the wall 630 and the interior wall surface 667 are arranged substantially parallel to one another so that contact between the two aligns the mounting surface 629 of the engine block 505 and the mounting surface 684 of the crankcase cover 515. The wall 690 is inserted into the opening 677 to a depth where the mounting surface 629 contacts the mounting surface 684 around the entire circumference of the mounting surfaces 629 and 684. Once aligned in this manner, the mounting surfaces 629 and 684 are welded together to secure the crankcase cover 515 to the engine block 505. In some embodiments, the mounting surfaces 629 and 684 are laser welded together. In some embodiments, the weld is formed along the outer circumference of the mounting surfaces 629 and 684 and extends inward from the outer edges 631 and 686 of the mounting surfaces. In other embodiments, separate mechanical fasteners (e.g. bolts) are used to secure the crankcase cover 515 to the engine block 505 after aligning the mounting surfaces 629 and 684 as described above.

Referring to FIGS. 19-26, a crankcase cover 516 for a horizontal shaft engine is illustrated according to an exemplary embodiment. As noted above, features that are common to the vertical shaft crankcase cover 515 and the horizontal shaft crankcase cover 516 are described with the same reference numerals.

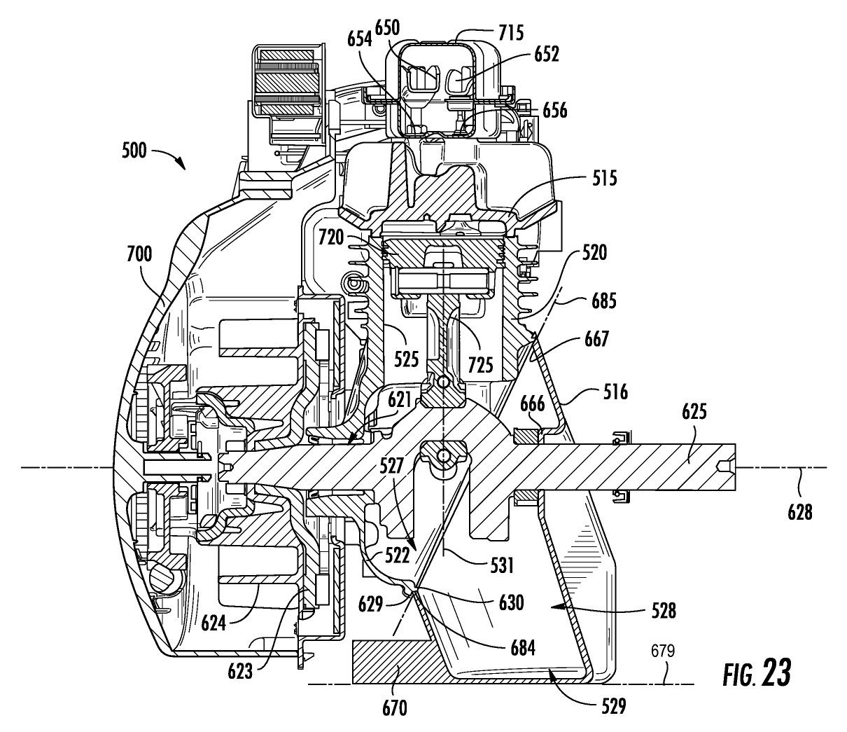

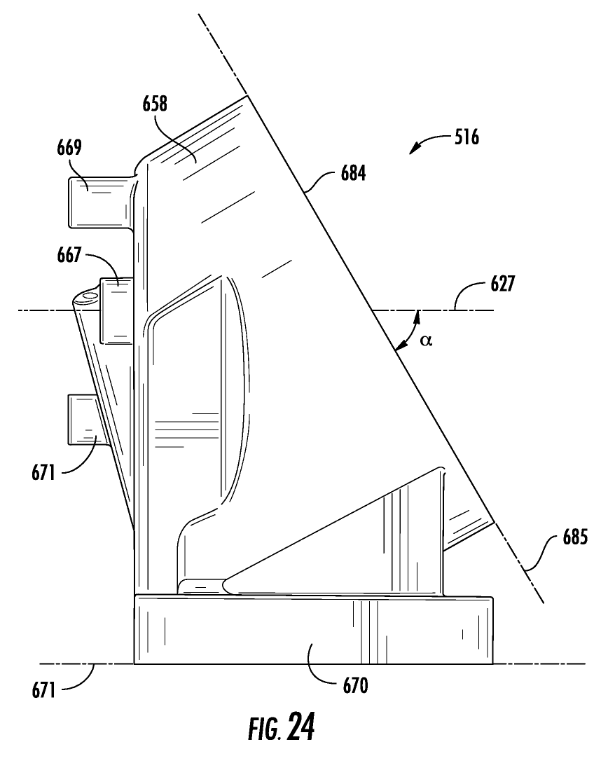

As shown in FIG. 23, the mounting flange 670 of the crankcase cover 516 is arranged so that the mounting plane 679 is located substantially parallel to the crankshaft axis 628 and substantially perpendicular to the cylinder axis 531 so that the engine 500 is arranged as a horizontal shaft engine when the mounting flange 670 is used to secure the crankcase cover 516 to the mounting location of the equipment to be powered by the engine. The mounting flange 670 includes a set of openings arranged in a standard horizontal engine support pattern. Bolts or other fasteners are inserted through the openings to attach the mounting flange 670 at a desired mounting location. Like the engine mounting patterns discussed above, horizontal engine support patterns are standardized (e.g., by SAE or other standard setting organizations for small internal combustion engines).

As shown in FIG. 26, the crankcase cover 516 includes a number of engine mounting locations arranged in a standard horizontal shaft engine mounting pattern (e.g., an SAE or other industry standard for mounting small internal combustion engines) around the crankshaft opening 662. As illustrated, the crankcase cover 516 includes four mounting locations 669, 671, 673, and 675, each including a boss and a corresponding opening to allow a bolt or other fastener to be secured at each support location. The mounting location 669, 671, 673, and 675 are used to secure an implement (e.g., a transmission) to the engine 500 to be driven by the engine 500.

The crankcase cover 516 is attached to the engine block 505 by inserting the wall 630 of the engine bock 505 into the opening 677 defined by the inner edge 688 of the cover body 658 so that the outer surface of the wall 630 contacts a portion of an interior wall surface 667 of the cover body 658. Contact between the outer surface of the wall 630 and the interior wall surface 667 aligns the mounting surface 629 of the engine block 505 and the mounting surface 684 of the crankcase cover 515. The wall 690 is inserted into the opening 677 to a depth where the mounting surface 629 contacts the mounting surface 684 around the entire circumference of the mounting surfaces 629 and 684. Once aligned in this manner, the mounting surfaces 629 and 684 are welded together to secure the crankcase cover 515 to the engine block 505. In some embodiments, the mounting surfaces 629 and 684 are laser welded together. In some embodiments, the weld is formed along the outer circumference of the mounting surfaces 629 and 684 and extends inward from the outer edges 631 and 686 of the mounting surfaces. In other embodiments, separate mechanical fasteners (e.g. bolts) are used to secure the crankcase cover 516 to the engine block 505 after aligning the mounting surfaces 629 and 684 as described above.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments.

Other substitutions, modifications, changes, and omissions may be made in the design, operating conditions and arrangement of the exemplary embodiments without departing from the scope of the present disclosure.

Although the figures may show or the description may provide a specific order of method steps, the order of the steps may differ from what is depicted. Also two or more steps may be performed concurrently or with partial concurrence. Such variation will depend on various factors, including software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A small air-cooled internal combustion engine, comprising:
an aluminum engine block including a cylinder extending along a longitudinal cylinder axis and a block mounting surface;
a piston configured to reciprocate within the cylinder;
a crankshaft coupled to the piston and configured to rotate about a crankshaft axis in response to reciprocation of the piston; and
an aluminum crankcase cover including a cover mounting surface;
wherein the block mounting surface contacts the cover mounting surface; and
wherein the block mounting surface and the cover mounting surface are both positioned at an angle to the crankshaft axis and the angle is not 90 degrees.

2. The small air-cooled internal combustion engine of claim 1, wherein the angle is 25 degrees.

3. The small air-cooled internal combustion engine of claim 1, wherein the angle is at least 5 degrees.

4. The small air-cooled internal combustion engine of claim 1, wherein the aluminum engine block further includes a flange extending away from the block mounting surface and the flange contacts an interior vertical wall surface of the aluminum crankcase cover.

5. The small air-cooled internal combustion engine of claim 1, wherein the aluminum crankcase cover further includes a mounting flange configured for attaching the engine to a piece of equipment.

6. The small air-cooled internal combustion engine of claim 5, wherein the mounting flange defines a flange mounting surface and the flange mounting surface is positioned substantially perpendicular to the crankshaft axis.

7. The small air-cooled internal combustion engine of claim 5, wherein the mounting flange defines a flange mounting surface and the flange mounting surface is positioned substantially parallel to the crankshaft axis.

8. The small air-cooled internal combustion engine of claim 1, wherein the block mounting surface and the cover mounting surface are welded to one another.

9. The small air-cooled internal combustion engine of claim 1, wherein the aluminum engine block and the aluminum crankcase cover each define a portion of a crankcase reservoir.

10. The small air-cooled internal combustion engine of claim 9, wherein the aluminum engine block does not include a lubricant inlet to add lubricant to the crankcase reservoir.

11. The small air-cooled internal combustion engine of claim 9, wherein a mechanical governor is not located in the crankcase reservoir.

12. The small air-cooled internal combustion engine of claim 11, further comprising an electronic governor for controlling engine speed.

13. The small air-cooled internal combustion engine of claim 9, wherein the engine does not include a dipstick for measuring a lubricant level within the crankcase reservoir.

14. A small air-cooled internal combustion engine, comprising:
an engine block including a cylinder extending along a longitudinal cylinder axis and a block mounting surface;
a piston configured to reciprocate within the cylinder;
a crankshaft coupled to the piston and configured to rotate about a crankshaft axis in response to reciprocation of the piston; and
a crankcase cover including a cover mounting surface;
wherein the block mounting surface contacts the cover mounting surface; and
wherein the block mounting surface and the cover mounting surface are both positioned at an angle to the crankshaft axis and the angle is not 90 degrees.

15. The small air-cooled internal combustion engine of claim 14, wherein the angle is 25 degrees.

16. The small air-cooled internal combustion engine of claim 14, wherein the angel is at least 5 degrees.

17. The small air-cooled internal combustion engine of claim 14, wherein the engine block further includes a flange extending away from the block mounting surface and the flange contacts an interior vertical wall surface of the crankcase cover.

18. The small air-cooled internal combustion engine of claim 14, wherein the crankcase cover further includes a mounting flange configured for attaching the engine to a piece of equipment.

19. The small air-cooled internal combustion engine of claim 18, wherein the mounting flange defines a flange mounting surface and the flange mounting surface is positioned substantially perpendicular to the crankshaft axis.

20. The small air-cooled internal combustion engine of claim 18, wherein the mounting flange defines a flange mounting surface and the flange mounting surface is positioned substantially parallel to the crankshaft axis.
